(19) United States
(12) Patent Application Publication
(10) Pub. No.: US 2003/0170487 A1
(43) Pub. Date: Sep. 11, 2003

(54) Exterior component for portable timepiece and portable timepiece

(76) Inventor: Shigeru Miyama, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/385,184

(22) Filed: Mar. 10, 2003

(30) Foreign Application Priority Data
Mar. 11, 2002 (JP) 2002-065139

(51) Int. Cl. B32B 15/00

(52) U.S. Cl. 428/660; 428/651; 428/685

(57) ABSTRACT

An exterior component for a portable timepiece having decorativeness and corrosion resistance and the portable timepiece are to be provided. In a double-layer clad material, the inside of a timepiece case is made of a titanium material and the outside is made of a pure aluminum material. In the pure aluminum material, alumite treatment is carried out from a surface to a given depth. A step portion is provided in the upper portion of the timepiece case, a glass fixing packing is fitted in the step portion, and glass is press-fitted here. A backside cover is fixed to an upper face of a movement. The movement with the backside cover is arranged so that a step portion for a face provided in the timepiece case is in contact with a part of the face. The backside cover is screwed into the timepiece case until the backside cover is in contact with a contact face of backside cover of the timepiece case, to be fixed to the timepiece case. A crown is partially inserted in a through hole provided in the timepiece case, and the backside cover is engaged with the movement arranged in the timepiece case.

### BACKGROUND OF THE INVENTION

1. Field of the Invention

The present invention relates to an exterior component for a portable timepiece, which is characterized by employing a clad material.

2. Description of the Prior Art

In the exterior component for the portable timepiece of the prior art, a pure aluminum material, an aluminum alloy material, stainless steel, a titanium material, or the like is utilized according to its purpose. In these metal materials, the pure aluminum material and the aluminum alloy material are adopted for the exterior component for the portable timepiece including a decorative plate, because the pure aluminum material and the aluminum alloy material are lightweight and exhibit good workability and coloring is possible by carrying out alumite treatment.

The stainless steel has good corrosion resistance and the good workability, and surface treatment is also easy, so that the stainless steel is most adopted as the exterior component for the portable timepiece. In recent years, the titanium material has also been adopting as the exterior component for the portable timepiece, because the titanium material is light and has the excellent corrosion resistance and metal allergy resistance. When decoration is given to the exterior component for the portable timepiece which is made of the stainless steel or the titanium material, it is general that mirror surface, moire, and satin finish is carried out by polishing and then metal plating is carried out if necessary.

Products utilizing the pure aluminum material or the aluminum alloy material are used for various components of portable devices besides the exterior component for the portable timepiece, the alumite treatment is carried out to those components. Since an alumite treatment film has the excellent corrosion resistance, wear resistance, and coloring, it is useful for decorative goods. However, when once the alumite treatment film is destroyed by some cause, violent corrosion occurs to the pure aluminum material or the aluminum alloy material as a raw material. Particularly, when the pure aluminum material or the aluminum alloy material is used as the exterior component for the portable timepiece, a large quantity of corrosion is generated in a backside portion, a crown portion, a band engaging portion, and a connecting portion of band blocks where perspiration and grime are easy to gather by touching human's skin in wearing. And the corrosion rapidly proceeds.

The stainless steel or the titanium material has the excellent corrosion resistance, polishing, and the like, and plenty of stainless steel or titanium material is used as the exterior component for the portable timepiece. However, the stainless steel is limited to gold, gray, black, and the like when the coloring is carried out by the surface treatment, therefore, the stainless steel can not meet the coloring demand of various kinds of articles. In the titanium material, mirror workability is bad and color tone of the material is dark.

That is to say, since there is no exterior component for the portable timepiece which has both decorativeness and the corrosion resistance, there was a problem that adaptable components and usable conditions are restricted.

### SUMMARY OF THE INVENTION

Therefore, the invention provides the exterior component for the portable timepiece, which has both decorativeness and the good corrosion resistance, and the portable timepiece using the exterior component for the portable timepiece.

The exterior component for the portable timepiece according to the invention is one in which a double-layer clad material including the titanium material or the stainless steel and the pure aluminum material or the aluminum alloy material is used and the alumite treatment is carried out to the pure aluminum material or the aluminum alloy material.

The exterior component for the portable timepiece according to the invention is one in which, in the double-layer clad material, the pure aluminum material or the aluminum alloy material is three-dimensionally worked in a convexo-concave shape and the alumite treatment is carried out to the convexo-concave portion.

The exterior component for the portable timepiece according to the invention is one in which the pure aluminum material or the aluminum alloy material is three-dimensionally worked in a convex shape to provide a convex portion, all but the convex portion of the pure aluminum material or the aluminum alloy material are removed, and the alumite treatment is carried out to the convex portion.

The exterior component for the portable timepiece according to the invention is one in which a multi-layer clad material including the titanium material or the stainless steel and the pure aluminum material or the aluminum alloy material is used and decoration in a striped pattern is given to the pure aluminum material or the aluminum alloy material by the alumite treatment.

The portable timepiece according to the invention has the exterior component for the portable timepiece.

### BRIEF DESCRIPTION OF THE SEVERAL VIEWS OF THE DRAWINGS

A preferred form of the present invention is illustrated in the accompanying drawings in which:

FIG. 1 is a sectional view of a periphery of a crown portion in a portable timepiece using a double-layer clad material;

FIG. 2 is a sectional view of a periphery of band engaging portion in a portable timepiece case using the double-layer clad material;

FIG. 3 is a sectional view of a part of an exterior component for the portable timepiece according to the invention, in which the double-layer clad material including a titanium material or stainless steel and a pure aluminum material or an aluminum alloy material is used, an unnecessary part of the pure aluminum material or an aluminum alloy layer is removed while the pure aluminum material or the aluminum alloy layer is left in the convex shape, and then decoration is given by alumite treatment; and

FIG. 4 is a sectional view of a glass trim using a multi-layer clad material.

### DETAILED DESCRIPTION OF THE PREFERRED EMBODIMENTS

In the exterior component for the portable timepiece according to the invention, the clad material of the titanium and the pure aluminum material or the aluminum alloy material, or clad material of the stainless steel and the pure aluminum material or the aluminum alloy material is used as the raw material, utilizing properties of the pure aluminum material or the aluminum alloy material having the lightweight and the good workability, which improvement of the corrosion resistance and the free coloring can be achieved by the alumite treatment, and the titanium material or the stainless steel having the excellent corrosion resistance and strength.

When the exterior component for the portable timepiece is worked, the pure aluminum material or the aluminum alloy material of the clad material is arranged in a part where the decorativeness is required, the titanium material or the stainless steel of the clad material is arranged in the crown portion, the band engaging portion, and the connecting portion of band blocks where the corrosion resistance or material strength is required and the perspiration and the grime are easy to gather by touching human's skin.

The alumite treatment layer has a thickness not lower than 0.01 mm, adjusted by alumite treatment conditions so that the whole layer of the pure aluminum material or the aluminum alloy material of the clad material is not varied to the alumite treatment layer.

The preferable thickness of the alumite treatment layer is not lower than 0.015 mm, and a part of the pure aluminum material layer or the aluminum alloy material layer in contact with the titanium material or the stainless steel of the clad material is left as the pure aluminum material layer or the aluminum alloy material layer with the thickness of not lower than 0.1 mm.

The reason that the pure aluminum material layer or the aluminum alloy material layer is left with the thickness of not lower than 0.1 mm is that the layer formed by the alumite treatment layer is hard and brittle, being aluminum oxide (Al₂O₃). That is, being a part of the pure aluminum material layer or the aluminum alloy material layer, the residual pure aluminum material layer or the residual aluminum alloy material layer has very good adhesiveness for the pure aluminum material or the aluminum alloy material, but the residual pure aluminum material layer or the residual aluminum alloy material layer has the bad adhesiveness for the titanium material or the stainless steel, thus, peeling-off occurs by impact and the like when the whole pure aluminum material layer or the whole aluminum alloy material layer is changed to the alumite treatment layer.

The titanium material portion or the stainless steel portion of the clad material is slightly colored by the alumite treatment. When the coloring is an obstacle to product quality, the coloring is removed by the polishing. The colored layer of the titanium material or the stainless steel has the thickness of about 500 Å, so that the colored layer can be easily removed by buffing without any influence on the alumite treatment layer.

As a result, the coloring necessary for the decoration is given by the alumite treatment of the pure aluminum material layer or the aluminum alloy material layer, durability and the corrosion resistance are given by the titanium material layer or the stainless steel layer, so that the exterior component for the portable timepiece which has the excellent corrosion resistance, durability, and decorativeness can be provided.

When the pure aluminum material portion or the aluminum alloy material portion of the clad material is worked in the convexo-concave shape and the same alumite treatment is carried out, the exterior component for the portable timepiece which has the further excellent decorativeness can be also provided.

A stereoscopic pattern can be formed in such a manner that, after the pure aluminum material layer or the aluminum alloy material layer is three-dimensionally worked in the convex shape, all but the convex portion of the pure aluminum material or the aluminum alloy material are removed, and the same alumite treatment is carried out to the convex portion, the innovative exterior component for the portable timepiece which has the excellent decorativeness can be also provided.

When the multi-layer clad material in which the titanium material and the pure aluminum material or the aluminum alloy material are alternately arranged or the multi-layer clad material in which the stainless steel and the pure aluminum material or the aluminum alloy material are alternately arranged is used, the striped pattern can be expressed in various ways, and the innovative exterior component for the portable timepiece which has the excellent decorativeness can be also provided.

### EXAMPLE

The exterior component for the portable timepiece according to the invention will be described on the basis of drawings. In the double-layer clad material according to the invention, as a combination of its metal materials, there are the titanium material and the pure aluminum material, the titanium material and the aluminum alloy material, the stainless steel and the pure aluminum material, and the stainless steel and the aluminum alloy material. Because an effect in these four combinations is the same, the case in which the double-layer clad material combining the titanium material with the pure aluminum material is used will be described.

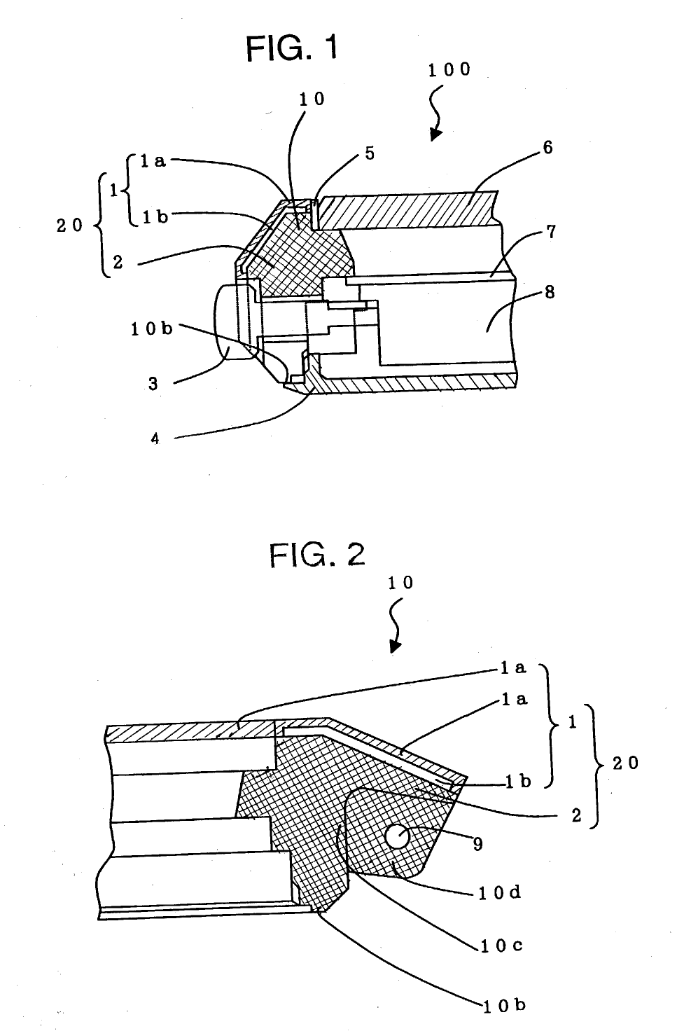

FIG. 1 is a sectional view of the portable timepiece, particularly, in the vicinity of the crown portion, when the double-layer clad material is used as the timepiece case of the exterior component for the portable timepiece.

A portable timepiece 100 includes a case 10, glass 6, a glass fixing packing 5, a crown 3, a backside cover 4, a face 7, and a movement 8. A double-layer clad material 20 made of a titanium material 2 and a pure aluminum material 1 is used for the timepiece case 10. In the double-layer clad material 20, the inside of the timepiece case 10 is the titanium material 2 and the outside is the pure aluminum material 1. In the pure aluminum material 1, the alumite treatment is carried out from a surface to a given depth. For example, an alumite treatment layer 1a is formed up to the depth of not lower than 0.15 mm of a surface layer in the pure aluminum material 1, the alumite treatment is carried out so that a residual part where the alumite treatment is not given to the pure aluminum material 1 (non-alumite treatment layer) 1b is not lower than 0.1 mm. The decorativeness is heightened by carrying out the alumite treatment. On the other hand, since the titanium material 2 has the excellent durability and corrosion resistance, by arranging the titanium material 2 inside the timepiece case 10, the alumite treatment layer 1a is prevented from always contacting with the skin. When the double-layer clad material 20 is used for the timepiece case 10, the decorativeness and the durability or the corrosion resistance of the timepiece case 10 can be possessed simultaneously.

A step portion is provided in the upper portion of the timepiece case 10, and the glass fixing packing is fitted in the step portion, where the glass 6 is press-fitted. The backside cover 4 is fixed to the upper face of a movement 8. The movement 8 with the backside cover 4 is arranged so that a step portion for the face provided in the timepiece case 10 is in contact with a part of the face 7. The backside cover 4 is screwed into the timepiece case 10 until the backside cover 4 is in contact with a contact face of backside cover 10b of the timepiece case 10, to be fixed to the timepiece case 10. The crown 3 is partially inserted in a through hole provided in the timepiece case 10, and the backside cover 4 is engaged with the movement 8 arranged in the timepiece case 10. Since the perspiration and the grime are easy to gather by touching the skin in wearing, the titanium material 2 is used in the crown portion in which the crown 3 of the timepiece case 10 necessary for the corrosion resistance and the material strength is inserted, a backside portion 2b which is easy to contact with the skin, and the like.

The method which the backside cover 4 is fixed to the timepiece case 10 may be one which a concave portion is provided in the timepiece case 10 and a dowel portion of the backside cover 4 is engaged with the concave portion.

FIG. 2 is a sectional view of the timepiece case, particularly, in the vicinity of a band engaging portion, when the double-layer clad material is used as the timepiece case of the exterior component for the portable timepiece.

By using the double-layer clad material 20 of the titanium material 2 and the pure aluminum material 1, the pure aluminum material 1 is arranged on the surface layers of the upper face and a side portion of the timepiece case 10 as the exterior component for the portable timepiece. In the pure aluminum material 1, the outside is formed by an alumite layer 1a to which the alumite treatment is carried out and the inside is formed by the pure aluminum material 1b to which the alumite treatment is carried out. The alumite treatment is carried out so that the alumite treatment layer 1a is up to the depth of the surface layer not lower than 0.15 mm of the aluminum material 1 and the pure aluminum 1b as the residual portion of the pure aluminum material 1 is not lower than 0.1 mm.

In the band engaging portion 10c, a side face of band engaging portion 10d, and a contact face of back side cover contact surface 10b, since the perspiration and the grime gather by touching the skin in wearing, the titanium material 2 which requires the corrosion resistance and the material strength is used. In the side face of band engaging portion 10d, a band fitting hole 9 for installing the band has been previously made.

Consequently, the pure aluminum material 1 contribute to the decorativeness, the titanium material 2 contributes to the durability and the corrosion resistance of the band engaging portion, so that the excellent exterior component for the portable timepiece can be provided.

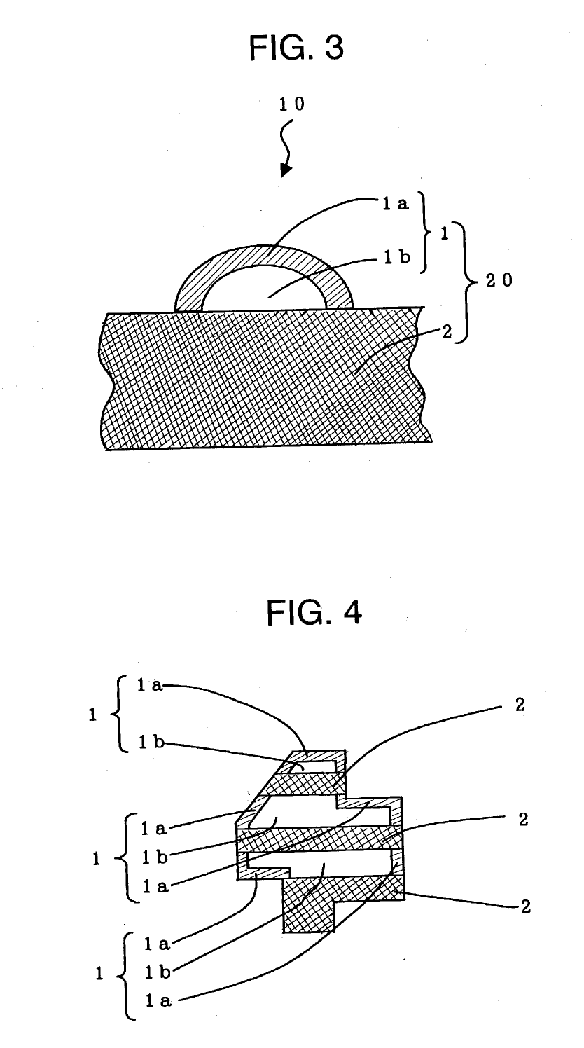

FIG. 3 is a sectional view when the aluminum material is three-dimensionally worked in the convex shape in the exterior component for the portable timepiece made of the double-layer clad material.

By using the double-layer clad material 20 of the titanium material 2 and the pure aluminum material 1, the pure aluminum material 1 is arranged on the surface layers of the upper face and a side portion of the timepiece case 10, the pure aluminum material 1 is three-dimensionally worked in the convex shape. Further, all but the convex portion of the pure aluminum material 1 are removed to form the convex portion made of the pure aluminum material 1 on the surface of the titanium material 2. After the formation of the convex portion, the alumite treatment is carried out to the convex portion. The alumite treatment is carried out so that the alumite layer 1a is up to the depth of the surface layer not lower than 0.15 mm and the residual portion 1b of the convex portion is not lower than 0.1 mm.

As a result, the exterior component for the portable timepiece, which is able to express the stereoscopic pattern and has the excellent decorativeness, can be provided.

FIG. 4 is a sectional view when the multi-layer clad material is used as a glass trim of the exterior component for the portable timepiece.

By using the multi-layer clad material in which the titanium material 2 and the pure aluminum material 1 are alternately arranged, the multi-layer clad material is worked to the glass trim of the exterior component for the portable timepiece. Then, the alumite treatment is carried out to the pure aluminum material 1. The alumite treatment is carried out so that the alumite treatment layer 1a is up to the depth of the surface layer not lower than 0.15 mm and the residual portion 1b of the pure aluminum material 1 is not lower than 0.1 mm.

In particular, in the case of combination with forging and application of a difference in “elongation” which is one of material characteristics, various kinds of striped patterns can be expressed. This also allows the innovative exterior component for the portable timepiece having the excellent decorativeness to be provided.

As described above, according to the invention regarding the exterior component for the portable timepiece in which the clad material is used, it is possible to provide the exterior component for the portable timepiece having both the excellent decorativeness of the pure aluminum or the aluminum alloy material and the excellent corrosion resistance and the material strength of the titanium material or the stainless steel.

What is claimed is:

1. An exterior component for a portable timepiece comprising:
a double-layer clad material including a titanium material and a pure aluminum material;
wherein alumite treatment is carried out to the pure aluminum material.

2. An exterior component for a portable timepiece comprising:
a double-layer clad material including a titanium material and an aluminum alloy material;
wherein alumite treatment is carried out to the aluminum alloy material.

3. An exterior component for a portable timepiece comprising:
a double-layer clad material including a stainless steel and a pure aluminum material;
wherein alumite treatment is carried out to the pure aluminum material.

4. An exterior component for a portable timepiece comprising:
a double-layer clad material including a stainless steel and an aluminum alloy material;
wherein alumite treatment is carried out to the aluminum alloy material.

5. An exterior component for a portable timepiece as claimed in claim 1;
wherein the double-layer clad material provides that the pure aluminum material is three-dimensionally worked in a convexo-concave shape and the alumite treatment is carried out to the convexo-concave portion.

6. An exterior component for a portable timepiece as claimed in claim 2;
wherein the double-layer clad material provides that the aluminum alloy material is three-dimensionally worked in a convexo-concave shape and the alumite treatment is carried out to the convexo-concave portion.

7. An exterior component for a portable timepiece as claimed in claim 3;
wherein the double-layer clad material provides that the pure aluminum material is three-dimensionally worked in a convexo-concave shape and the alumite treatment is carried out to the convexo-concave portion.

8. An exterior component for a portable timepiece as claimed in claim 4;
wherein the double-layer clad material provides that the aluminum alloy material is three-dimensionally worked in a convexo-concave shape and the alumite treatment is carried out to the convexo-concave portion.

9. An exterior component for a portable timepiece as claimed in claim 1;
wherein the pure aluminum material is three-dimensionally worked in a convex shape to provide a convex portion, all but the convex portion of the pure aluminum material are removed, and the alumite treatment is carried out to the convex portion.

10. An exterior component for a portable timepiece as claimed in claim 2;
wherein the aluminum alloy material is three-dimensionally worked in a convex shape to provide a convex portion, all but the convex portion of the aluminum alloy material are removed, and the alumite treatment is carried out to the convex portion.

11. An exterior component for a portable timepiece as claimed in claim 3;
wherein the pure aluminum material is three-dimensionally worked in a convex shape to provide a convex portion, all but the convex portion of the pure aluminum material are removed, and the alumite treatment is carried out to the convex portion.

12. An exterior component for a portable timepiece as claimed in claim 4;
wherein the aluminum alloy material is three-dimensionally worked in a convex shape to provide a convex portion, all but the convex portion of the aluminum alloy material are removed, and the alumite treatment is carried out to the convex portion.

13. An exterior component for a portable timepiece comprising:
a multi-layer clad material including a titanium material and a pure aluminum material;
wherein decoration in a striped pattern is given to the pure aluminum material by alumite treatment.

14. An exterior component for a portable timepiece comprising:
a multi-layer clad material including a titanium material and an aluminum alloy material;
wherein decoration in a striped pattern is given to the aluminum alloy material by alumite treatment.

15. An exterior component for a portable timepiece comprising:
a multi-layer clad material including a stainless steel and a pure aluminum material;
wherein decoration in a striped pattern is given to the pure aluminum material by alumite treatment.

16. An exterior component for a portable timepiece comprising:
a multi-layer clad material including a stainless steel and an aluminum alloy material;
wherein decoration in a striped pattern is given to the aluminum alloy material by alumite treatment.

17. A portable timepiece comprising:
an exterior component having a double-layer clad material including a titanium material and a pure aluminum material;
wherein alumite treatment is carried out to the pure aluminum material.

18. A portable timepiece comprising:
an exterior component having a double-layer clad material including a titanium material and an aluminum alloy material;
wherein alumite treatment is carried out to the aluminum alloy material.

19. A portable timepiece comprising:
an exterior component having a double-layer clad material including a stainless steel and a pure aluminum material;
wherein alumite treatment is carried out to the pure aluminum material.

20. A portable timepiece comprising:
an exterior component having a double-layer clad material including a stainless steel and an aluminum alloy material;
wherein alumite treatment is carried out to the aluminum alloy material.

21. A portable timepiece comprising:
an exterior component having a multi-layer clad material including a titanium material and a pure aluminum material;
wherein decoration in a striped pattern is given to the pure aluminum material by alumite treatment.

22. A portable timepiece comprising:
an exterior component having a multi-layer clad material including a titanium material and an aluminum alloy material;
wherein decoration in a striped pattern is given to the aluminum alloy material by alumite treatment.

23. A portable timepiece comprising:
an exterior component having a multi-layer clad material including a stainless steel and a pure aluminum material;
wherein decoration in a striped pattern is given to the pure aluminum material by alumite treatment.

24. A portable timepiece comprising:
an exterior component having a multi-layer clad material including a stainless steel and an aluminum alloy material;
wherein decoration in a striped pattern is given to the aluminum alloy material by alumite treatment.
